(19) United States
(12) Patent Application Publication
(10) Pub. No.: US 2008/0290182 A1
(43) Pub. Date: Nov. 27, 2008

(54) SYSTEM AND METHOD FOR CALCULATING WAIT-TIME FOR CHECKOUT

(75) Inventors: Kevin H. Bell, Wake Forest, NC (US); Angela Richards Jones, Durham, NC (US); Jessica S. K. Snead, Cary, NC (US)

Correspondence Address: CANTOR COLBURN LLP - IBM RESEARCH TRIANGLE PARK, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/752,727

(22) Filed: May 23, 2007

(51) Int. Cl. G06F 19/00; G06F 17/00

(52) U.S. Cl. 235/61 V; 705/7

(57) ABSTRACT

A system for using one or more criteria in order to calculate a wait-time in a business establishment, the system comprising: one or more checkout lanes located at the business establishment; a display screen positioned at each of the one or more checkout lanes; a bar code reading station; a light switch; a personal shopping assistant device utilized by each customer for receiving and transmitting first information; a central processing station for collecting second information from each display screen, bar code reading station, personal shopping assistant device, and light switch of each of the one or more checkout lanes; wherein the central processing station calculates an estimated wait time for each of the one or more checkout lanes based on the information collected and farther displays the estimated wait time of each of the one or more checkout lanes on the respective display screen.

### TRADEMARKS

IBM® is a registered trademark of International Business Machines Corporation, Armonk, N.Y., U.S.A. Other names used herein may be registered, trademarks, trademarks or product names of International Business Machines Corporation or other companies.

### BACKGROUND OF THE INVENTION

1. Field of the Invention

This invention relates to checkout lines, and particularly to a method of utilizing several criteria not accessible to customers for calculating a wait time for every checkout line of a retail store.

2. Description of Background

Many retail stores such as grocery stores and clothing stores have several checkout lines available in order to ensure that the customer is able to check out in the least amount, of time possible. However, the problem is that customers have to gauge what line they think would be the fastest to go through. This is currently done manually, as the customer determines which line may have the least amount of people in it. Nevertheless, most times the lines have about the same number of people in each one, so the customer randomly chooses one to stand in. Although the lines contain about the same number of people, some move at a faster pace than others. This frustrates the customer as the customer realizes that he/she didn't choose the most optimal line to be in.

Considering the above limitations, it is desired to have a method of utilizing several criteria not accessible to customers for calculating a wait time for every checkout, line of a retail store.

### SUMMARY OF THE INVENTION

The shortcomings of the prior art are overcome and additional advantages are provided through the provision of a system for using one or more criteria in order to calculate a wait-time in a business establishment comprising: one or more checkout lanes located at the business establishment; a display screen positioned at each of the one or more checkout lanes; a bar code reading station located at each of the one or more checkout lanes; a light switch located at each of the one or more checkout lanes; a personal shopping assistant device utilized by each customer for receiving and transmitting first information; a central processing station for collecting second information from each display screen, bar code reading station, personal shopping assistant device, and light switch of each of the one or more checkout lanes; wherein the central processing station calculates an estimated wait time for each of the one or more checkout lanes based on the information collected and further displays the estimated wait time of each of the one or more checkout lanes on the respective display screen.

The shortcomings of the prior art are overcome and additional advantages are provided through the provision of a method for using one or more criteria in order to calculate a wait-time in a business establishment, the method comprising: one or more checkout lanes located at the business establishment for calculating the wait-time by implementing the steps of: positioning at each of the one or more checkout lanes a display screen; positioning at each of the one or more checkout lanes a bar code reading station; positioning at each of the one or more checkout lanes a light switch; receiving and transmitting first information via a personal shopping assistant device utilized by each customer; collecting second information from each display screen, bar code reading station, personal shopping assistant device, and light switch of each of the one or more checkout lanes via a central processing station; wherein the central processing station calculates an estimated wait time for each of the one or more checkout lanes based on the information collected and further displays the estimated wait time of each of the one or more checkout lanes on the respective display screen.

Additional features and advantages are realized through the techniques of the present invention. Other embodiments and aspects of the invention are described in detail herein and are considered a part of the claimed invention. For a better understanding of the invention with advantages and features, refer to the description, and the drawings.

### TECHNICAL EFFECTS

As a result of the summarized invention, technically we have achieved a solution of a method of utilizing several criteria not accessible to customers for calculating a wait time for every checkout line of a retail store.

### BRIEF DESCRIPTION OF THE DRAWINGS

The subject matter, which is regarded as the invention, is particularly pointed out and distinctly claimed in the claims at foe conclusion of the specification. The foregoing and other objects, features, and advantages of the invention are apparent from the following detailed description taken in conjunction with the accompanying drawings in which:

FIG. 1 is a system diagram for calculating the checkout time of every checkout line at a retail store, in accordance with an embodiment of the invention; and

FIG. 2 is a method for calculating the checkout time of every checkout line at a retail store, in accordance with an embodiment of the invention.

### DETAILED DESCRIPTION OF THE INVENTION

One aspect of the exemplary embodiments is a system and method for using criteria not accessible to customers in order to calculate a wait time for each checkout line and give the customers a more accurate way to choose a line. This will make the checkout experience faster and more efficient, which, in turn, will increase customer satisfaction and will allow the business to make money at a faster pace.

Every checkout line would include a display screen showing the calculated wait time. To calculate the wait lime for a particular checkout line, the disclosed system uses criteria that is not accessible to the customers, such as cashiers scan rate, how many items in the line need to be processed, and typical checkout habits of the customers in line. How each of these parameters is used is outlined below:

Parameter 1: Cashier's scan rate: When a specific cashier checks into or logs onto a checkout station, the central processing station monitors the cashier's scan rate. Therefore, data such as if a cashier scans 12 items per minute on average or if a cashier takes approximately 4 minutes per transaction are logged in and sent to the central processing station for further processing.

Parameter 2: How many items in the line need to be processed: This could be achieved by using Radio Frequency Identification (RFID) technology or by using a “Personal Shopping Assistant” (PSA) device with the ability to read a barcode of every item that is entered into a shopping cart. In the exemplary embodiments, a PSA could include a store-provided shopping assistant device with a barcode reader, and it could also represent a consumer owned device, such as a PDA/cell-phone equipped with shopping software. RFID tags can also be added to the shopping carts themselves. Each checkout line would be aware of how many shopping carts were in the checkout line, and also how many and what types of items are in the checkout cart.

For example, some items may need to be scanned, while other items may need to he weighed (e.g., produce). This would also be factored into the estimated wait-lime calculation. To determine the items that need to be processed, any of the following embodiments can be used;

(1) An RFID reading station can be placed at each checkout line that would read the RFID tags that are on the shopping carts that are in the checkout line. Once the RFID reader recognizes the items, this information is sent to the calculator, which then sends the information to the display screen at the beginning of each checkout line.

(2) The customer could allow his/her PSA to know what line he/she has gotten into. The PSA would then send the information about the person's shopping cart to the calculator to process.

(3) Vertical sensors can be added to the floor to direct customers as to where to stand for the next spot in line. These sensors can use RFID technology to determine what items the customer has. In addition, if a PSA is used, the floor sensors can communicate with the PSA device to determine what items the customer has. This information is then sent to the system to make the calculation, and display it on the display screen at the beginning of each line.

Parameter 3: Typical checkout habits by using loyalty cards: This parameter can be achieved by determining if the customer typically pays with cash, credit, or check. It can also be determined if the customer usually buys specific items, such as cigarettes or liquor, as this will add time to the checkout experience since the cashier will need to ask the customer for ID, and may need to leave the station to get the cigarettes or liquor. Another use of the loyalty card would be to determine if the customer typically uses coupons, and if so how many, as this can also add time to the overall checkout experience.

If the customer uses a PSA, then the loyalty card would have already been scanned and this information can be sent to the calculator when the person enters the checkout line. If the RFID reading station or the floor sensor is used, they can detect when the customer enters the line and grab the information from their loyalty card at that point.

As a result, the system calculations would rely on as much information as is available. However, as all of the above information may not be available due to the type of technology existing in the store, calculations can still be made based on averages, allowing estimates to be produced and used accordingly.

Once all of the information is sent to the system for calculation, it can determine how long it will take to process the customers that are in line. The system calculations also automatically adjust as people leave and enter the line. This can be accomplished with, a simple “heartbeat” check to each of the information receiving devices, with configurable time intervals.

Many existing cashier stations contain a light switch, which allows cashiers to make the light flash when they need assistance for things such as price checks or manager assistance. The flashing light could trigger the calculator to add an approximate interruption time to the wait time display.

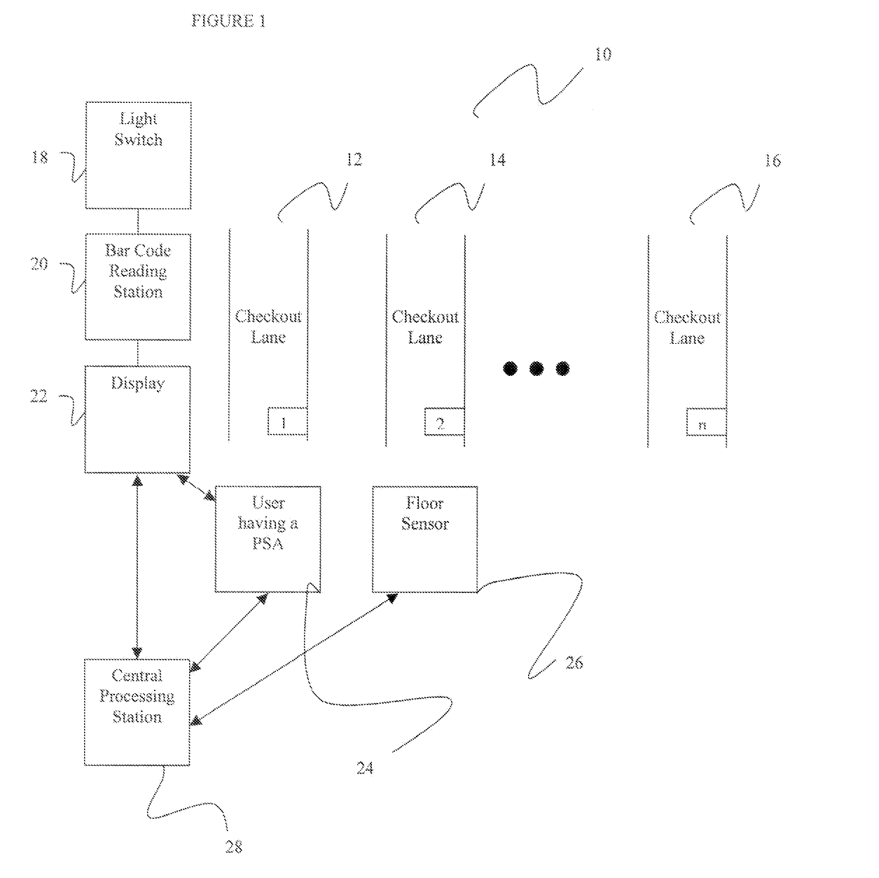

Referring to FIG. 1, a system diagram for calculating the checkout time of every checkout line at a retail store, in accordance with an embodiment of the invention is illustrated. The system 10 includes a first checkout lane 12, a second checkout lane 14, an nth checkout lane 16, a light switch 18, a bar code reading station 20, a display 22, a user having a PSA 24, a floor sensor 26, and a central processing station 28.

Each checkout lane contains a light switch 18, a bar code reading station 20, a display 22, and a floor sensor 26. A user having a PSA 24 may access any checkout lane and have the PSA 24 interact with the display 22. The central processing station 28 collects data from the PSA 24, the bar code reading station 20, the light switch 18, and the floor sensor 26. The central processing station may provide information directly to the PSA 24 or it may send information directly to the display 22. The user having the PSA 24 may directly access information from the display 22. The central processing station collects all this information to calculate an estimated wait-time for each checkout lane.

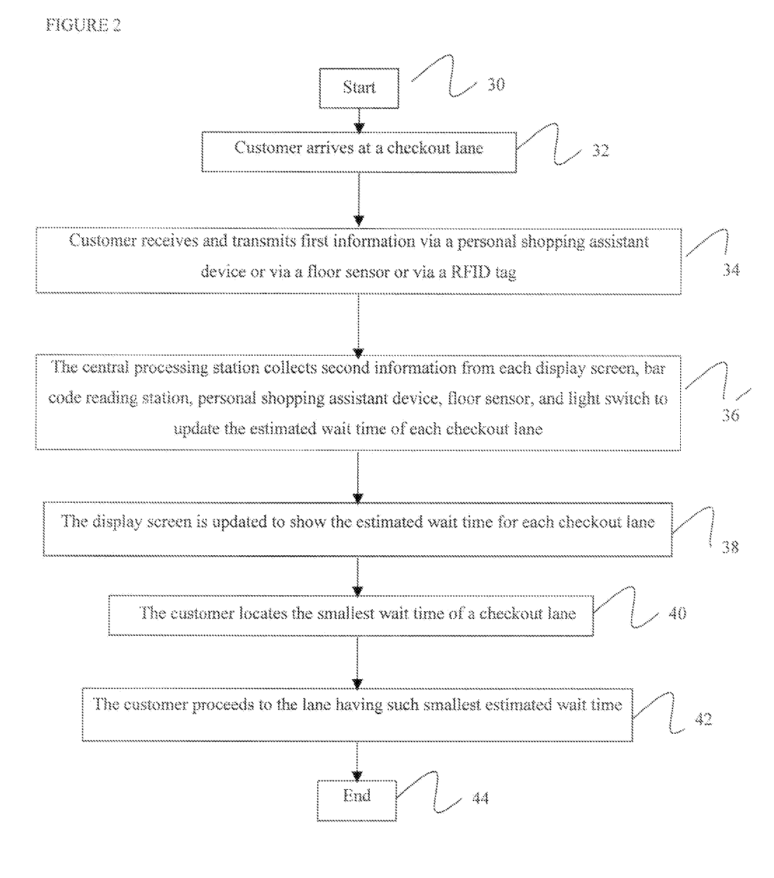

Referring to FIG. 2, a method for calculating the checkout time of every checkout line at a retail store, in accordance with an embodiment of the invention is illustrated. In one exemplary embodiment, the checkout time flow diagram may be illustrated as follows. In step 30, the processing starts. In step 32, the customer arrives at the checkout lane. In step 34, the customer receives and transmits first information via either a personal shopping assistant device or via a floor sensor or via a RFID tag. In step 36, the central processing station collects second information from each display screen, bar code reading station, personal shopping assistant device, floor sensor, and light switch to update the estimated wait time of each checkout lane. In step 38, the display screen is updated to show the estimated wait time for each checkout lane. In step 40, the customer locates the smallest wait time of a checkout lane. In step 42, the customer proceeds to the checkout lane having the smallest estimated wait time. In step 44, the process ends and the customer goes home happy. One ordinary skilled in the art can easily switch these steps around or add or remove steps to this flow diagram. This flow diagram merely presents one general way of performing this method of estimating a wait time for each checkout line in a business establishment.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system lot using one or more criteria in order to calculate a wait-time for one or more checkout lanes included within a business establishment, the system comprising:
a display screen positioned at each of the one or more checkout lanes;
a bar code reading station located at each of the one or more checkout lanes;
a light switch located at each of the one or more checkout lanes;
a personal shopping assistant device utilized by a customer of the business establishment, for receiving and transmitting first information;
a central processing station for collecting second information from each display screen, bar code reading station, personal shopping assistant device, and light switch of each of the one or more checkout lanes;
wherein the central processing station calculates an estimated wait time for each of the one or more checkout lanes based on the information collected and further displays the estimated wait time of each of the one or more checkout lanes on the respective display screen.

2. The system of claim 1, wherein the one or more criteria include a cashier's scan rate, a number of previously processed items per lane, and checkout habits of each customer in the one or more checkout lanes.

3. The system of claim 1, wherein each of the one or more checkout lanes sends to the central processing station, via the personal shopping assistant device, a number of checkout carts and all the items located in each of the checkout carts for each of the one or more checkout lanes.

4. The system of claim 1, wherein one or more floor sensors are positioned at each of the one or more checkout lanes to determine a number of checkout carts and all the items located in each of the checkout carts and send such data either to the central processing station or to the personal shopping assistant device.

5. The system of claim 1, wherein checkout habits of each customer waiting in the one or more checkout lanes are stored in a loyalty card, and wherein each of the loyalty cards includes previous items purchased and previous methods of payment sent to the central processing station via the personal shopping assistant device.

6. The system of claim 1, wherein the estimated wait time for each of the one or more checkout lanes is transmitted directly to the personal shopping assistant device.

7. The system of claim 1, wherein Radio Frequency identification (RFID) tags are placed on each of a plurality of shopping carts to communicate with the central processing station.

8. The system of claim 1, wherein one display screen displays the estimated wait time of all the one or more checkout lanes.

9. A method for calculating a wait-time for one or more checkout lanes included within a business establishment, the method comprising:
receiving and transmitting first information via a personal shopping assistant device utilized by each customer;
collecting second information from one or more display screens, one or more bar code reading stations, one or more personal shopping assistant devices, and one ore more light switches, positioned at of each of the one or more checkout lanes, via a central processing station;
wherein the central processing station calculates an estimated wait time for each of the one or more checkout lanes based on the information collected and further displays the estimated wait time of each of the one or more checkout lanes on the respective display screen.

10. The method of claim 9, wherein the one or more criteria include a cashier's scan rate, how many items in the lane were previously processed, and checkout habits of each customer in the one or more checkout lanes.

11. The method of claim 9, wherein each of the one or more checkout lanes sends to the central processing station, via the personal shopping assistant device, a number of checkout carts and all the items located in each of the checkout carts for each of the one or more checkout lanes.

12. The method of claim 9, wherein one or more floor sensors are positioned at each of the one or more checkout lanes to determine a number of checkout carts and all the items located in each of the checkout carts and send such data either to the central processing station or to the personal shopping assistant device.

13. The method of claim 9, wherein checkout habits of each customer waiting in the one or more checkout lanes are stored in a loyalty card, and wherein each of the loyalty cards includes previous items purchased and previous methods of payment sent to the central processing station via the personal shopping assistant device.

14. The method of claim 9, wherein the estimated wait time for each of the one or more checkout lanes is transmitted directly to the personal shopping assistant device.

15. The method of claim 9, wherein Radio Frequency Identification (RFID) tags are placed on each of a plurality of shopping carts to communicate with the central processing station.

16. The method of claim 9, wherein one display screen displays the estimated wait time of all the one or more checkout lanes.
